(19) United States
(12) Patent Application Publication
(10) Pub. No.: US 2026/0289418 A1
(43) Pub. Date: Sep. 24, 2026

(54) Machine Learning Approach to Multi-Domain Process Automation and User Feedback Integration

(71) Applicant: SISCALE AI, INC., Norwood, NJ (US)

(72) Inventors: Gheorghe Bogdan Perian, Timis (RO); Petrica Ruta, Norwood, NJ (US); Iulia Adriana Muntianu, Bucharest (RO); Alina Elena Marcu, Bucharest (RO); Calin Alexandru Cornigeanu, Timis (RO); Bogdan Sass, Bucharest (RO)

(21) Appl. No.: 19/688,059

(22) Filed: May 26, 2026

Related U.S. Application Data
(63) Continuation of application No. 17/166,319, filed on Feb. 3, 2021, now abandoned.

(51) Int. Cl. G06N 20/00; G06F 16/28; G06N 5/04

(52) U.S. Cl. CPC G06N 20/00; G06F 16/285; G06N 5/04

(57) ABSTRACT

Embodiments relate to multi-domain process automation with user feedback integration. Some embodiments include a method performed by one or more computing devices. The one or more computing devices generate, using a machine learning (ML) model, predictions for records. The one or more computing devices receive at least one of single user feedback or multiple user feedback for the predictions. The one or more computing devices generate a user validated record pool based on the single user feedback or multiple user feedback. The one or more computing devices update the ML model using the user validated record pool.

### CROSS REFERENCE TO RELATED APPLICATION

This application is a continuation of U.S. Application No. 17/166,319, filed Feb. 3, 2021, which is incorporated by reference in all entirety.

### TECHNICAL FIELD

The present disclosure relates to multi-domain process automation with user feedback integration.

### BACKGROUND

Complex computing processes can be improved by collecting and analyzing records. For example, record analysis can be applied to noise filtering to detect cybersecurity threats in computing systems, root cause analysis to detect errors in computing systems, or capacity planning and forecasting for computing systems. While human operators can review records and detecting issues, the large volumes of records that can be generated by computing systems make reliance on manual review impractical or impossible. As such, it is desirable to use a machine learning (ML) approach to process automation that effectively integrates user knowledge in order to improve the accuracy of the results in an iterative, continuous manner.

### SUMMARY

Embodiments relate to multi-domain process automation and user knowledge integration, presented as feedback to a ML model inferred output. Some embodiments include a method performed by one or more computing devices. The one or more computing devices generate, using a machine learning (ML) model, predictions for records. The one or more computing devices receive at least one of single user feedback or multiple user feedback for the predictions. The one or more computing devices receive the multiple user feedback for the selected subset of the predictions. The one or more computing devices generate a user validated record pool based on the single user feedback or multiple user feedback. The one or more computing devices update the ML model using the user validated record pool.

In some embodiments, the method further includes, by the one or more computing devices: receiving the single user feedback for each of the predictions; selecting a subset of the predictions for the multiple user feedback by a plurality of users; receiving the multiple user feedback for the selected subset of the predictions; and determining an agreement result for each of the selected subset of the predictions based on the multiple user feedback, wherein generating the user validated record pool includes incorporating the agreement result for the selected subset of predictions.

In some embodiments, a prediction is selected for the multiple user feedback when the single user feedback for the prediction indicates user uncertainty regarding accuracy of the prediction.

In some embodiments, the subset of the predictions for the multiple user feedback is selected based on analyzing similarity of the records.

In some embodiments, the subset of the predictions for the multiple user feedback is selected based on confidence levels of the predictions.

In some embodiments, the subset of the predictions for the multiple user feedback is selected based on user accuracy ratings.

In some embodiments, for each prediction selected for the multiple user feedback, determining the agreement result includes determining a majority voting agreement.

In some embodiments, for each prediction selected for the multiple user feedback, determining the agreement result includes weighting the multiple user feedback based on user accuracy rating.

In some embodiments, for each prediction selected for the multiple user feedback, determining the agreement result includes performing a consensus iteration including a higher-level agreement process that is used when a lower-level agreement process fails to determine the agreement result.

In some embodiments, the method further includes, by the one or more computing devices and prior to generating the predictions for the features of the records using the ML model: storing, in one or more storage modules, a pool of ML models including the ML model and a collection of datasets; and providing a user interface to a user device for defining a ML job, wherein defining the ML job includes: selecting a job category, the job category being associated with the ML model; and selecting a dataset from the collection of datasets, wherein the ML model is trained using the dataset.

In some embodiments, the method further includes, by one or more computing devices, adding the ML model trained using the user validated record pool to the pool of ML models as a later version of the ML model trained using the dataset.

In some embodiments, the method further includes, by one or more computing devices, validating the ML job defined by the user by verifying compatibility between the ML model associated with the job category and the dataset.

Some embodiments include a system. The system includes one or more computing devices configured to: generate, using a machine learning (ML) model, predictions for records; receive at least one of single user feedback or multiple user feedback for the predictions; generate a user validated record pool based on the single user feedback or multiple user feedback; and update the ML model using the user validated record pool.

In some embodiments, the one or more computing devices are further configured to: receive the single user feedback for each of the predictions; select a subset of the predictions for the multiple user feedback by a plurality of users; receive the multiple user feedback for the selected subset of the predictions; and determine an agreement result for each of the selected subset of the predictions based on the multiple user feedback, wherein generating the user validated record pool includes incorporating the agreement result for the selected subset of predictions.

In some embodiments, the one or more computing devices are configured to select a prediction for the multiple user feedback when the single user feedback for the prediction indicates user uncertainty regarding accuracy of the prediction.

In some embodiments, the one or more computing devices are configured to select the subset of the predictions for the multiple user feedback based on analyzing similarity of the records.

In some embodiments, the one or more computing devices are configured to select the subset of the predictions for the multiple user feedback based on confidence levels of the predictions.

In some embodiments, the one or more computing devices are configured to select the subset of the predictions for the multiple user feedback based on user accuracy ratings.

In some embodiments, the one or more computing devices are configured to determine the agreement result for each prediction selected for the multiple user feedback, by determining a majority voting agreement.

In some embodiments, the one or more computing devices are configured to determine the agreement result for each prediction selected for the multiple user feedback by weighting the multiple user feedback based on user accuracy rating.

In some embodiments, the one or more computing devices are configured to determine the agreement result for each prediction selected for the multiple user feedback by performing a consensus iteration including a higher-level agreement process that is used when a lower-level agreement process fails to determine the agreement result.

In some embodiments, the one or more computing devices are further configured to, prior to generating the predictions for the features of the records using the ML model: store, in one or more storage modules, a pool of ML models including the ML model and a collection of datasets; and provide a user interface to a user device for defining a ML job, wherein defining the ML job includes: selecting a job category, the job category being associated with the ML model; and selecting a dataset from the collection of datasets, wherein the ML model is trained using the dataset.

In some embodiments, the one or more computing devices are further configured to add the ML model trained using the user validated record pool to the pool of ML models as a later version of the ML model trained using the dataset.

In some embodiments, the one or more computing devices are further configured to validate the ML job defined by the user by verifying compatibility between the ML model associated with the job category and the dataset.

Some embodiments include a non-transitory computer readable medium comprising stored instructions, which when executed by a processor, cause the processor to: generate, using a machine learning (ML) model, predictions for records; receive at least one of single user feedback or multiple user feedback for the predictions; generate a user validated record pool based on the single user feedback or multiple user feedback; and update the ML model using the user validated record pool.

### BRIEF DESCRIPTION OF THE DRAWINGS

Thedisclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example set of processes for process automation with user knowledge integration, in accordance with some embodiments.

FIG. 2 illustrates an example process for providing user feedback that is integrated to update a ML model, in accordance with some embodiments.

FIG. 3 is a block diagram of a computing system for process automation with user feedback integration, in accordance with some embodiments.

FIG. 4 illustrates a diagram of processes used for continuous improvement of a ML model, in accordance with some embodiments.

FIG. 5 is a block diagram of a computer, in accordance with some embodiments

### DETAILED DESCRIPTION

Aspects of the present disclosure relate to a machine learning approach to multi-domain process automation and user feedback integration. In some embodiments, a process automation system leverages structured and unstructured data to reduce investigation/analysis efforts and encode human experience in algorithmic mechanisms. The system incorporates user feedback with deep learning techniques, such as supervised, unsupervised, active, or reinforcement learning. The system provides a process automation platform that is applicable to different domains, organizations, industries, and verticals. Some example domains may include root cause analysis for errors in computing systems (e.g., on storage clusters, automated machinery in industrial environments, etc.), noise filtering for data sets (e.g., related to cybersecurity), or capacity planning and forecasting for computing systems.

For example, one or more computing devices generate, using a machine learning (ML) model, predictions based on record features. The one or more computing devices select a subset of the predictions for multiple user feedback by a plurality of users. The one or more computing devices receive the multiple user feedback for the selected subset of the predictions. For each prediction selected for multiple user feedback, the one or more computing devices determine an agreement result using the feedback from the plurality of users. The one or more computing devices generate a multiple user validated record pool using the agreement result for the selected subset of predictions. The one or more computing devices generate a user validated record pool, composed of single and multiple user validated record predictions. The one or more computing devices train the ML model using the user validated record pool.

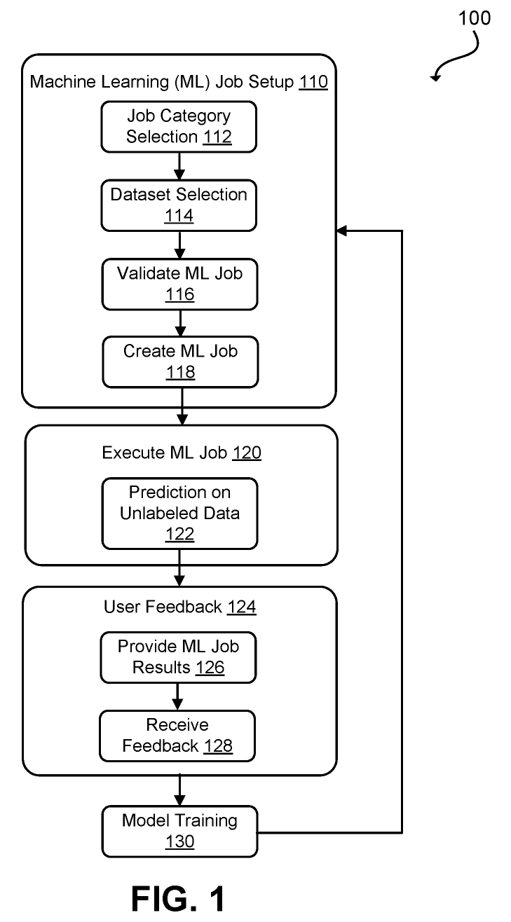

FIG. 1 illustrates an example set of processes 100 for process automation with user knowledge integration. The processes 100 show how users interact with a process automation system and steps involved in the user experience for ML job creation process and user feedback. Each of these processes can be structured and enabled as multiple modules or operations. The processes 100 provide for continuous improvement of ML models for process automation using user feedback. The processes begin with a machine learning (ML) job setup 110 where a user configures a ML job that will process one or more collected data sets. For example, the process automation system provides a user interface to a user device allowing the user to configure the ML job. The ML job setup includes selecting a job category 112, selecting a dataset 114, validating the ML job 116, and creating the ML job 118.

The job category selection 112 allows the user to select a category of the machine learning job. Each category is associated with one or more ML models. A pool of ML models may be stored in a storage module (e.g., a database) and retrieved based on the selected category. The pool of ML models may include different types of ML models, such as sequence-to-sequence models, long short-term memory (LSTM) models, recurrent models, among other deep learning techniques. An example of a category of machine learning jobs is alert triage, which uses a ML model including hybrid deep neural architectures that may include multiple types of layers (such as convolutional, recurrent or fully-connected) which outputs a confidence score and a class from a predefined set of classes. Another example of a category of machine learning job is tasks involving long-term dependencies from multiple sources in the case of root cause analysis for errors in computing systems, which uses a sequence-to-sequence ML model that outputs an informative message. The job category selection 112 may be a first filtering criteria for selection from the pool of ML models.

Data selection 114 allows the user to select a dataset, such as from a database storing a collection of datasets for different types of processes. The datasets may be provided by the process automation system, integrations with various tools or systems, or directly by users. For example, initial datasets used for generating pretrained ML models may be provided by the process automation system to the users. Users can also provide their own datasets to the process automation system which can be processed by existing ML models. The selected dataset may provide for a second filtering criteria for selection of the ML model. The selection of the ML model may be based on the category, the selected dataset, or both. In some embodiments, the selected job category is used to select a group of candidate ML models from the pool, and the selected dataset is used to select a ML model from the candidate ML models.

After ML model selection, the ML job is validated 116 and created 118. The selected job category, dataset, ML model, and other parameters of the ML job are validated and stored in the system for subsequent usage. The created ML job may be stored in association with the user or an organization of the user. The validation includes a first validation step that includes checking user input parameters to ensure the provided information is valid. For example, the process automation system verifies that the selected category is a valid entry in the system and the dataset exists and can be used. A second validation step includes verifying the compatibility between the registered ML models and the dataset. For example, this validation may include checking dataset structure and attribute types to ensure that the ML model can be applied on the selected dataset. A third validation step includes a dry run of the ML job, if there is no issue in the dry run the configured ML job is considered valid and is registered in the system. The system may also perform other types of validation. For example, validation may be applied for both security reasons and to improve the user experience. If validation fails for the ML Job creation, the user is provided with further information on what went wrong and potential resolutions. The user may change the job category, dataset, ML model, etc. until a validated ML job has been created.

After the ML job is created, the ML job is executed 120. Executing the ML job triggers the processing of data or records based on the configured parameters. Executing the ML job may include generating predictions or classifications on unlabeled data. The unlabeled data includes input data without associated outputs, and the ML model may generate the associated outputs as the predictions. For example, the unlabeled data is provided as input to circuitry that implements a neural network including the ML model, and the output of the circuitry includes data defining the predictions. In one example, the unlabeled data includes records of a system with various features and the predictions include classifications of the records into (e.g., predefined) classes.

User feedback 710 includes providing ML job results 126 to users and receiving feedback 128 from the users. The users are human operators that review the records and the predictions of the ML model and provide feedback that includes corrections to incorrect predictions by the ML model. For example, generating the user feedback may include reviewing features including error messages and the classes assigned to the error messages by the neural network, and providing corrections to the incorrect classes. A subset of the records may be selected for multiple user feedback where feedback from multiple users is used to generate a consensus result (also referred to herein as an “agreement result”).

The ML model is trained 130 using the feedback received from the users. For example, the user feedback combined with the unlabeled data used for the prediction 122 to generate labeled data, and the labeled data is used to train the ML model. The processes 100 may be repeated, such as by placing the updated ML model into the pool of ML models for subsequent ML job setups, execution, user feedback, model training, and so forth. As such, the processes 100 can provide for a continuous improvement cycle for the ML model.

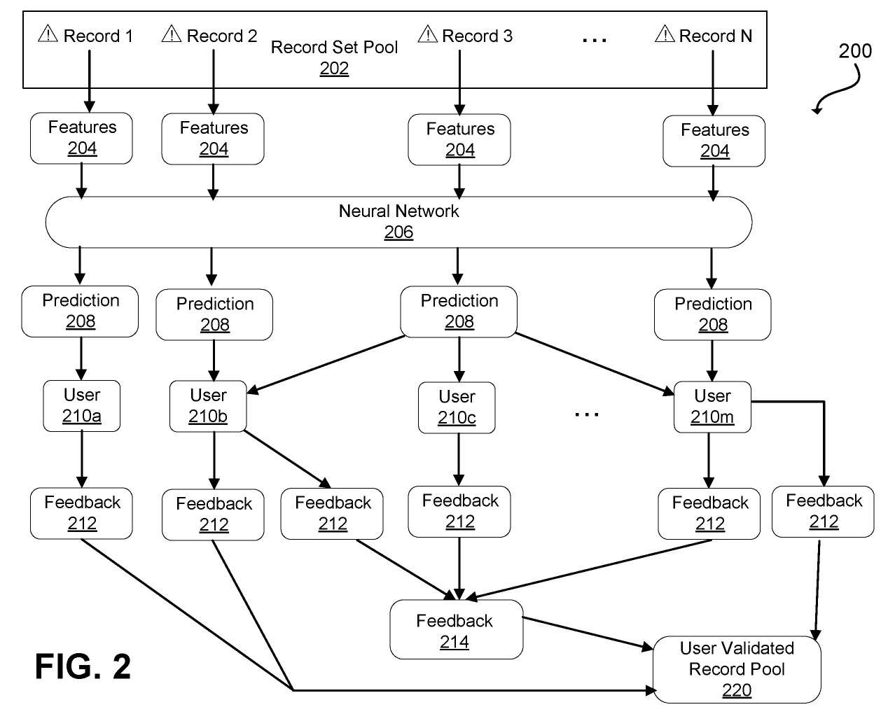

FIG. 2 illustrates an example process 200 for providing user feedback used to update a ML model. Unlabeled data used as input to the ML model may include records of activity in a computing system. Each record 1 through record N is placed into a record set pool 202. Multiple record sets are placed into the record set pool 202 and subjected to review. Each record set includes multiple individual records. Each record can be defined by a feature set having one or more features. Each record may include one or more features 204. An example of a feature may include an error message. The records from the record set pool 202 may be used as unlabeled data input to a neural network 206 that implements the ML model. The neural network 206 generates predictions 208 from the features of the records, where each record is assigned to one of a set of classes or a “not sure” class when none of the classes apply. For root cause analysis of errors, some examples of classes can include (1) an escalated status, (2) a dropped status, (3) a high importance status, (4) an ignore status, or (5) other. In the case of class “other”, the ML model may be used for extending the class pool in the continuous improvement process. For noise filtering, there may be a binary classification with two classes or labels, such as (1) dropped or (2) escalated. The number of classes and the types of classes can vary depending on the ML job.

The predictions 208 and features 204 of the records are sent to users 210athrough 210mto generate feedback 212. The feedback 212 may include reviewing the features and the predictions and providing a revised prediction for each feature where the output of the ML model is incorrect. The features and predictions may be provided to a user for review, which is referred to as “single user feedback.” At least some of the records and predictions may be provided to multiple users 210 for creation of “multiple user feedback”. The single user feedback records and multiple user feedback records are used to generate a user validated record pool 220. For example, record 3 is selected for human operator validation by users 210b, 210c, and 210m. Each of the users 210b, 210c, and 210mgenerates a single user feedback 212, and a multiple user feedback 214 is computed from the single user feedback 212. The multiple user feedback 214 is an agreement determined from the multiple instances of single user feedback 212. For example, if users 210band 210ceach classifies a record as having the escalated status but the user 210m classifies the record as having the dropped status, then the record may be determined to have the escalated status based on being the majority result.

Computing agreement for feedback may be performed in various ways. The voting session for a specific record where there are multiple (e.g., at least 3) operators involved is referred to herein as a “consensus iteration.” A consensus iteration may include multiple (e.g., 3) levels of agreement processes. In one embodiment, a level 1 agreement process is performed where a majority voting agreement is determined from the multiple user feedback. The majority voting may be based on feedback selected from high rated operators (e.g., above a defined threshold for accuracy). Furthermore, a weighted average of the feedback may be calculated based on operator rating (also referred to as “user accuracy rating”). Operator rating may be determined based on the number of times an operator was a part of the majority in a consensus iteration over the total number of times the operator provided feedback in consensus iterations.

If neither the majority voting nor weighted average produce an agreement, then a level 2 agreement process may be applied where majority voting agreement is gathered by votes from supervisors. Supervisors may be special operators having a higher rank than the operators that perform the level 1 agreement. The majority voting process of supervisors may override the level 1 agreement process.

If a consensus still cannot be reached, then a level 3 agreement process may be used where an administrator (e.g., highest ranked user) provides a final decision regarding the feedback result. This result may override all the lower level results.

In this example, the record 3 selected for multiple user validation is validated by three users but the number of users may vary. The records that receive multiple user validation may be selected from the record set pool 202 in various ways. For example, the selection of records for multiple user feedback may be based on (1) “not sure” button selections, (2) similarity, (3) confidence level, (4) prior lack of consensus, (5) operator scoring, or (5) supervising user selection. (1) The “not sure” button selection refers to when an operator provides feedback about being not sure about a classification of a record. (2) Similarity refers to prioritization of records with low percentages in similarity, thus increasing record diversity for multiple user feedback. (3) Confidence level refers to prioritizing records with low confidence level for output from the ML model for multiple user feedback. (4) Prior lack of consensus refers to the prioritization of records that were part of voting sessions where agreement was not reached for multiple user feedback. (5) Operator scoring refers to prioritization of records that were reviewed by lower rated operators for multiple user feedback. (6) Supervising user selection refers to allowing supervisors or administrators to manually select records for multiple user feedback. Other examples may include random record selection and prioritization based on record type or record importance. After creation, the single user feedback 212 and multiple user feedback 214 may be used to train the ML model of the neural network 206.

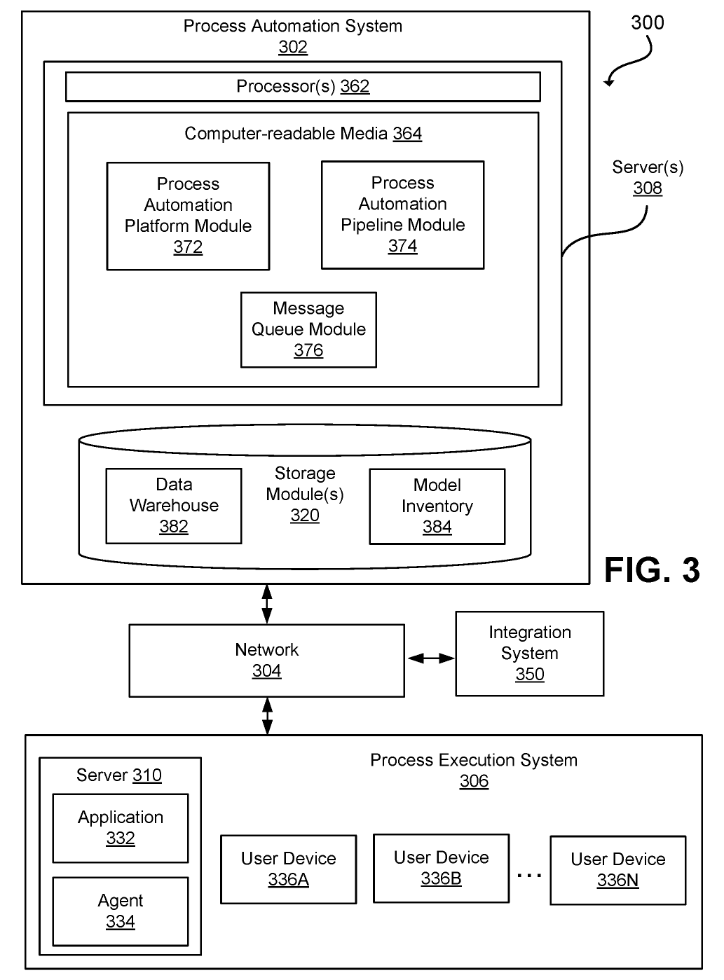

FIG. 3 is a block diagram of a computing system 300. The system 300 provides for process automation with user feedback integration. The system 300 includes a process automation system 302, a network 304, a process execution system 306, and an integration system 350. The process automation system 302 provides process automation for a process that executes on the process execution system 306. The network 304 may include a wide area network, such as the Internet. The network 304 may additionally or alternatively include a local area network. The network 304 may include wired or wireless connections.

The process execution system 306 includes a server 310 that executes an application 332. The server further includes an agent 334 that collects data regarding the application. The agent 334 may generate records regarding the operation of the application 332. The records are examples of unlabeled data that does not include predictions generated using a ML model. The agent 334 provides the reports to the process automation system 302 via the network 304. The agent 334 may be integrated with the application 334 or separate from the application 332.

The process execution system 306 may include one or more servers 310. Each of the servers 310 may include a physical machine or a virtual machine (e.g., of a cloud computing system). Each server 310 may execute an application 332 or parts of an application 332 while the agent 334 creates records regarding performance of the application 332.

The process execution system 306 further includes user devices 336A, 336B through 336N. A user device 336 may connect with the process automation system 302 to setup and execute a ML job. The ML job generates predictions using the data collected by the agent 334. The user devices 336A through 336N may also be used by human operators to create user feedback regarding the results of the ML job. This feedback may be used by the process automation system 302 to update the ML model for subsequent execution of the ML job. The user devices 336 may be separate from the process execution system 306.

The process automation system 302 includes one or more servers 308 and a storage module 320. A server 308 includes one or more processors 362 and a computer-readable media 364. The one or more processors 362 execute program modules that cause the one or more processors 362 to perform functionality. The processor(s) 362 may include one or more of a central processing unit (CPU), a graphics processing unit (GPU), both a CPU and a GPU, or other types of processing circuitry. A processor 362 may further include a local memory that stores program modules, operating system data, among other things.

The computer-readable media 364 is a non-transitory storage medium that stores program code for a process automation platform module 372, a process automation pipeline module 374, and a message queue module 376. The message queue module 376 facilitates communication between the process automation platform module 372 and the process automation pipeline module 374. The message queue module 376 may store input/output data for the process automation platform module 372 and the process automation pipeline module 374 to facilitate processing tasks.

The process automation platform module 372 allows users to interact with the process automation system 302, create ML jobs, review results of ML jobs, and provide feedback. For example, the process automation platform module 372 provides user interfaces for users to define and execute ML jobs, review the predictions output from the ML model, and provide feedback regarding the predictions that can be used to update the ML model.

The process automation pipeline module 374 performs ML job processing, ML model training, ML model generation, and feedback gathering from external systems, such as the integration system 350. The process automation pipeline module 374 may execute these processes automatically in response to receiving user inputs or automated triggered actions. Based on user actions or automatically triggered actions, the process automation pipeline module 374 receives signals through the message queue module 376. Based on the received signals, process automation pipeline module 374 executes the corresponding processing.

The process automation system 302 may include one or more servers 308. In one example, the process automation platform module 372, process automation pipeline module 374, and message queue module 376 may execute on separate servers. Each module 372, 374, or 376 may also each execute on multiple servers to distribute processing tasks. Each of the servers 308 may include a physical machine or a virtual machine (e.g., of a cloud computing system).

The one or more storage modules 320 store the data used by the process automation system 302. The storage module 320 may include a data warehouse 382 and a model inventory 384. The data warehouse 382 stores datasets, ML model predictions, and user feedback including the user validated record pool. The model inventory 384 stores a pool of ML models including multiple versions of ML models, ML model performance statistics, and model parameters. The data warehouse 382 and model inventory 384 may be separate databases.

The process automation system 302 may be connected to multiple process execution systems 306. Each process execution system 306 may represent a particular domain or use case. For each process of interest executed by the process execution systems 306, the process automation system 302 may manage a ML model and provide continuous ML model improvement via user feedback. A process execution system 306 may include various types of data collection systems, such as live data collection systems or historic data collection systems.

The integration system 350 is an external automated system that generates feedback. Like the operator generated feedback, the integration system 350 may provide feedback on predictions from ML models. The process automation system 320 may integrate the feedback into ML models.

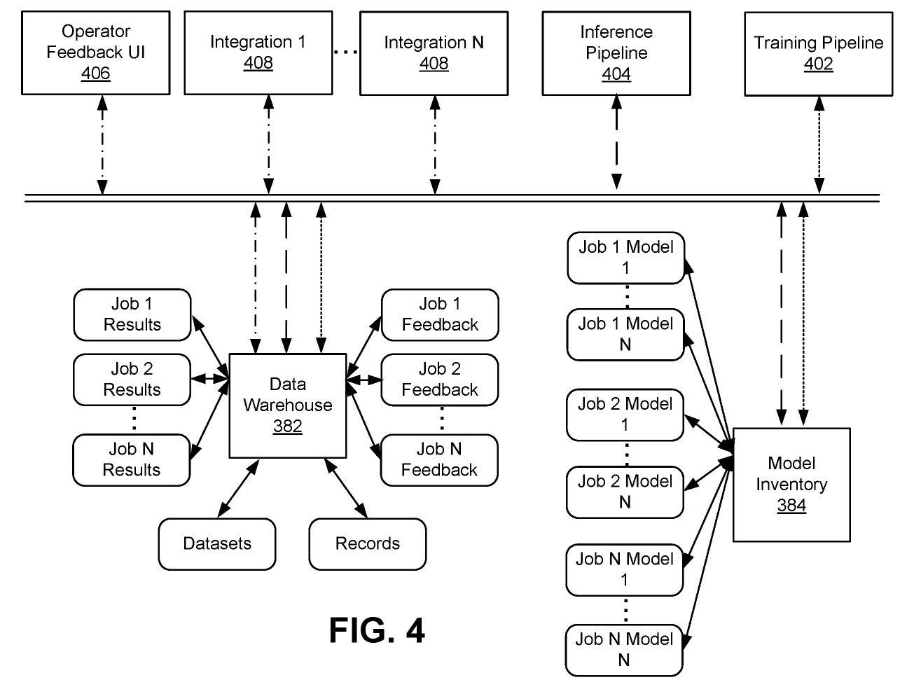

FIG. 4 illustrates a diagram of processes used for continuous improvement of a ML model. The processes 300 represents an automated cycle process that handles ML model inventory, dataset processing and user feedback processing.

The data warehouse 382 stores job results generated by ML models, including Job 1 Results, Job 2 Results… to Job N Results. The data warehouse 382 stores feedback regarding job results, which may be generated by users or integration systems, including Job 1 Feedback, Job 2 Feedback… to Job N Feedback. The data warehouse 382 stores datasets used to train ML models. The data warehouse 382 stores records used as input to ML models for generating predictions that are reviewed to generate the feedback.

The model inventory 483 stores ML models for ML jobs, which may include multiple versions (e.g., historic and current) of ML models for each ML job. For example, the model inventory 483 stores Job 1 Model 1 to Job 1 Model N for job 1, Job 2 Model 1 to Job 2 Model N for job 2, and Job 1 Model 1 to Job N Model N for job N.

The training pipeline 402 includes writing datasets to the data warehouse 384, reading datasets from the data warehouse 382 and ML models from the model inventory 384 to train ML models, and writing the trained ML models to the model inventory 384. The training pipeline 402 may include data ingestion, extraction of labeled data, data analysis, data preparation, feature engineering, model design, model training, and model evaluation and validation.

Data ingestion includes receiving data from various sources to generate datasets that are stored in the data warehouse 384. Different ML models may be associated with different domains or use cases. Each domain or use case may include an associated dataset. The data of the datasets may come from various (e.g., big) data sources, and arrive in different formats. Data extraction includes selecting and integrating labeled data from various data sources for a particular use case. The selected data that forms the dataset, along with a ML model from the model inventory 384, may be associated with the use case. Data analysis includes running statistics to identify the base data format that is suitable for the use case. Data preparation includes data cleaning and preprocessing through various deep-learning techniques. For example, the data of the dataset may be used to generate training datasets, validation datasets, and test datasets. Feature engineering includes applying transformation to the data to suit the target test. In one example, the output after applying feature engineering includes data strings in a specific format that is ready for model training. Model design includes implementing algorithms with pre-processed data to train the ML model. The model design may further include parameter tuning to optimize performance of the ML model. Model training includes training the ML model using the dataset. Model evaluation and validation includes evaluating the quality of the model. For example, a set of metrics may be generated to evaluate quality of the ML model predictions. Evaluating the model may include determining that model performance is better than a baseline level. After validation, the ML model is confirmed as ready for deployment.

The inference pipeline 404 includes reading trained ML models from the model inventory 384 and records from the data warehouse 382, executing inferencing jobs using the ML models and the records to generate the job results, and writing the job results to the data warehouse 382. The inferencing pipeline 404 may include model integration, where a ML model is deployed to a target environment. The deployed ML model uses the records, which may be new unlabeled data, to generate the job results, which are predictions. The records may be extracted from the data warehouse 382 or may be received from some other data source.

Operator feedback user interface (UI) 406 includes operators providing feedback. The operator feedback UI 406 reads the job results from the data warehouse 382 and writes the job feedback to the data warehouse 382. The integrations 1 to N 408 provide feedback from external automated systems. The integrations 1 to N 408 also reads job results from the data warehouse 382 and writes job feedback to the data warehouse 382. The feedback is used to generate training datasets (also referred to as “user validated record pools”) for model training via the training pipeline 402. The training datasets are used to improve subsequent inferencing using the ML models. The ML model trained using feedback datasets are placed into the pool of ML models. This process of training and inferencing may be repeated to generate refined versions of the ML models that are stored in the model inventory 384.

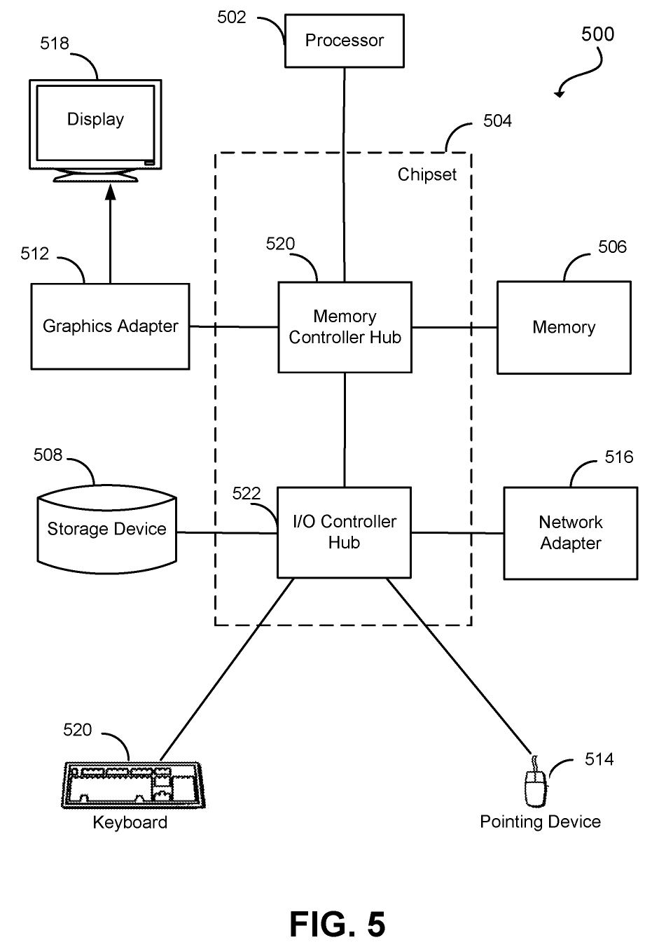

FIG. 5 is a block diagram of a computer 500. The computer 500 is an example of a computing device including circuitry that implements a component of the system 300, such as a server 302 of the process automation system 302 or user devices 336. Illustrated are at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display device 518 is coupled to the graphics adapter 512. A storage device 508, keyboard 510, pointing device 514, and network adapter 516 are coupled to the I/O controller hub 522. The computer 500 may include various types of input or output devices. Other embodiments of the computer 500 have different architectures. For example, the memory 506 is directly coupled to the processor 502 in some embodiments.

The storage device 508 includes one or more non-transitory computer-readable storage media such as a hard drive, compact disk read-only memory (CD-ROM), DVD, or a solid-state memory device. The memory 506 holds program code (e.g., instructions) and data used by the processor 502. The program code may correspond to the processing aspects described with reference to FIGS. 1-4.

The pointing device 514 is used in combination with the keyboard 510 to input data into the computer system 500. The graphics adapter 512 displays images and other information on the display device 518. In some embodiments, the display device 518 includes a touch screen capability for receiving user input and selections. The network adapter 516 couples the computer system 500 to a network. Some embodiments of the computer 500 have different and/or other components than those shown in FIG. 5.

In some embodiments, the circuitry that implements a process automation system may include an application-specific integrated circuit (ASIC), a field-programmable gate array (FPGA), or other types of computing circuitry.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Upon reading this disclosure, those of skill in the art will appreciate still additional alternative structural and functional designs for a system and a process for audio enhancement using device-specific metadata through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method, comprising, by one or more computing devices:
generating, with a process automation system by executing a machine learning (ML) model, a plurality of predictions for a plurality of records, each prediction of the plurality of predictions classifying one or more of the plurality of records in a class of a plurality of classes;
for each prediction:
responsive to the prediction indicating a class for the corresponding record is an unknown class, assigning at the process automation system, a new class to the prediction and identifying records of the plurality to be considered for validating the prediction;
receiving, at the process automation system from at least one client device, at least one of single user feedback describing a quality of the prediction;
determining, with the process automation system, whether to validate the prediction using single user feedback from a client device or multiple user feedback from two or more client devices based on the at least one single user feedback;
responsive to determining to validate the prediction using single user feedback, determining, with the process automation system, the prediction is a validated prediction based on the single user feedback from the client device when the single user feedback does not indicate the user is unsure about the prediction;
responsive to determining to validate the prediction using the multiple user feedback, determining, with the process automation system, the prediction is a validated prediction based on an agreement result representing a consensus of the multiple user feedback received from the two or more client devices for the prediction when the user feedback indicates that the user is unsure about the prediction;
generating, at the process automation system, an extended set of classes for the ML model based on the new class and the single user feedback and the multiple user feedback for the new class;
generating, with the process automation system, a user validated record pool based on the one or more validated predictions determined from the single user feedback and the one or more validated predictions determined from multiple user feedback;
updating, at the process automation system, a training dataset for the ML model to include the extended set of classes and updated features for the plurality of records based on the one or more validated predictions determined from the single user feedback and the one or more validated predictions determined from the multiple user feedback;
generating an updated ML model using the updated training set by further training the ML model, the updated model comprising an updated feature set and updated weights; and
storing, at the process automation system, the updated ML model, the updated training dataset, and performance metrics for the updated ML model.

2. The method of claim 1, further comprising, by the one or more computing devices:
receiving the single user feedback for each of the predictions;
selecting a subset of the predictions for the multiple user feedback by a plurality of users;
receiving the multiple user feedback for the selected subset of the predictions; and
determining an agreement result for each of the selected subset of the predictions based on the multiple user feedback, wherein generating the user validated record pool includes incorporating the agreement result for the selected subset of predictions.

3. The method of claim 2, wherein a prediction is selected for the multiple user feedback when the single user feedback for the prediction indicates user uncertainty regarding accuracy of the prediction.

4. The method of claim 2, wherein the subset of the predictions for the multiple user feedback is selected based on analyzing similarity of the records.

5. The method of claim 2, wherein the subset of the predictions for the multiple user feedback is selected based on confidence levels of the predictions.

6. The method of claim 2, wherein the subset of the predictions for the multiple user feedback is selected based on user accuracy ratings.

7. The method of claim 2, wherein, for each prediction selected for the multiple user feedback, determining the agreement result includes determining a majority voting agreement.

8. The method of claim 2, wherein, for each prediction selected for the multiple user feedback, determining the agreement result includes weighting the multiple user feedback based on user accuracy rating.

9. The method of claim 2, wherein, for each prediction selected for the multiple user feedback, determining the agreement result includes performing a consensus iteration including a higher-level agreement process that is used when a lower-level agreement process fails to determine the agreement result.

10. The method of claim 1, further comprising, by the one or more computing devices and prior to generating the predictions for the records using the ML model:
storing, in one or more storage modules, a pool of ML models including the ML model and a collection of datasets; and
providing a user interface to a user device for defining a ML job, wherein defining the ML job includes:
selecting a job category, the job category being associated with the ML model; and
selecting a dataset from the collection of datasets, wherein the ML model is trained using the dataset.

11. The method of claim 10, further comprising, by one or more computing devices, adding the ML model trained using the user validated record pool to the pool of ML models as a later version of the ML model trained using the dataset.

12. The method of claim 10, further comprising, by one or more computing devices, validating the ML job defined by the user device by verifying compatibility between the ML model associated with the job category and the dataset.

13. A system comprising:
one or more processors;
a non-transitory computer-readable storage medium comprising computer program instructions, the computer program instructions, when executed by the one or more processors, causing the one or more processors to:
generate, with a process automation system by executing a machine learning (ML) model, a plurality of predictions for a plurality of records, each prediction of the plurality of predictions classifying one or more of the plurality of records in a class of a plurality of classes;
for each prediction:
responsive to the prediction indicating a class for the corresponding record is an unknown class, assign at the process automation system, a new class to the prediction and identifying records of the plurality to be considered for validating the prediction;
receive, at the process automation system from at least one client device, at least one of single user feedback describing a quality of the prediction;
determine, with the process automation system, whether to validate the prediction using the single user feedback from a client device or multiple user feedback from two or more client devices based on the at least one single user feedback;
responsive to determining to validate the prediction using the single user feedback, determine, with the process automation system, the prediction is a validated prediction based on the single user feedback from the client device when the single user feedback does not indicate the user is unsure about the prediction; and
responsive to determining to validate the prediction using the multiple user feedback, determine, with the process automation system, the prediction is a validated prediction based on an agreement result representing a consensus of the multiple user feedback received from the two or more client devices for the prediction when the user feedback indicates that the user is unsure about the prediction;
generate, at the process automation system, an extended set of classes for the ML model based on the new class and the single user feedback and the multiple user feedback for the new class;
generate, with the process automation system, a user validated record pool based on the one or more validated predictions determined from the single user feedback and the one or more validated predictions determined from multiple user feedback;
update, at the process automation system, a training dataset for the ML model to include the extended set of classes and updated features for the plurality of records based on the one or more validated predictions determined from the single user feedback and the one or more validated predictions determined from the multiple user feedback;
generate an updated ML model using the updated training set by further training the ML model, the updated model comprising an updated feature set and updated weights; and
store, at the process automation system, the updated ML model, the updated training dataset, and performance metrics for the updated ML model.

14. The system of claim 13, wherein the computer program instructions, when executed by the one or more processors further cause the one or more processors to:
receive the single user feedback for each of the predictions;
select a subset of the predictions for the multiple user feedback by a plurality of users;
receive the multiple user feedback for the selected subset of the predictions; and
determine an agreement result for each of the selected subset of the predictions based on the multiple user feedback, wherein generating the user validated record pool includes incorporating the agreement result for the selected subset of predictions.

15. The system of claim 14, wherein the computer program instructions, when executed by the one or more processors further cause the one or more processors to select a prediction for the multiple user feedback when the single user feedback for the prediction indicates user uncertainty regarding accuracy of the prediction.

16. The system of claim 14, wherein the computer program instructions, when executed by the one or more processors further cause the one or more processors to select the subset of the predictions for the multiple user feedback based on analyzing similarity of the records.

17. The system of claim 14, wherein the computer program instructions, when executed by the one or more processors further cause the one or more processors to select the subset of the predictions for the multiple user feedback based on confidence levels of the predictions.

18. The system of claim 14, wherein the computer program instructions, when executed by the one or more processors further cause the one or more processors to select the subset of the predictions for the multiple user feedback based on user accuracy ratings.

19. The system of claim 14, wherein the computer program instructions, when executed by the one or more processors further cause the one or more processors to determine the agreement result for each prediction selected for the multiple user feedback by determining a majority voting agreement.

20. A method, comprising, by one or more computing devices:
generating, with a process automation system by executing a machine learning (ML) model, a plurality of predictions for a plurality of records, each prediction classifying one or more of the plurality of records in a class of a plurality of classes;
for each prediction:
responsive to the prediction indicating a class for a corresponding record is an unknown class, assigning at the process automation system, a new class to the prediction ;
receiving, at the process automation system from at least one client device, single user feedback describing a quality of the prediction;
determining, with the process automation system, whether to validate the prediction using the single user feedback or multiple user feedback from two or more client devices based on the single user feedback;
responsive to determining to validate the prediction using the single user feedback, determining the prediction is a validated prediction when the single user feedback does not indicate the user is unsure about the prediction;
responsive to determining to validate the prediction using the multiple user feedback, determining the prediction is a validated prediction based on a consensus of the multiple user feedback when the single user feedback indicates the user is unsure about the prediction;
generating, at the process automation system, an extended set of classes for the ML model based on the new class ;
generating, with the process automation system, a validated record pool based on one or more validated predictions determined from the single user feedback and one or more validated predictions determined from the multiple user feedback;
updating, at the process automation system, a training dataset for the ML model to include the extended set of classes and updated features for the plurality of records in the validated record pool ;
generating an updated ML model by further training the ML model using the updated training dataset, the updated ML model comprising an updated feature set and updated weights;
and storing the updated ML model and the updated training dataset.
